(19) United States
(12) Patent Application Publication
(10) Pub. No.: US 2026/0245983 A1
(43) Pub. Date: Aug. 20, 2026

(54) SHEET FOR RECHARGEABLE LITHIUM BATTERY AND RECHARGEABLE LITHIUM BATTERY INCLUDING SAME

(71) Applicant: SAMSUNG SDI CO., LTD., Gyeonggi-do (KR)

(72) Inventors: Tae Jin LEE, Gyeonggi-do (KR); Myungheui WOO, Gyeonggi-do (KR); Sanghoon KIM, Gyeonggi-do (KR); Arum YU, Gyeonggi-do (KR)

(73) Assignee: SAMSUNG SDI CO., LTD., Gyeonggi-do (KR)

(21) Appl. No.: 18/852,738

(22) PCT Filed: Aug. 18, 2022
(86) PCT No.: PCT/KR2022/012328

§ 371 Date: Sep. 30, 2024

(30) Foreign Application Priority Data
Apr. 1, 2022 (KR) 10-2022-0041241

(51) Int. Cl. H01M 10/42; B60L 50/60; H01M 10/0525; H01M 50/105

(52) U.S. Cl. CPC H01M 10/4235; H01M 10/0525; H01M 50/105; B60L 50/60

(57) ABSTRACT

Disclosed are a sheet for a rechargeable lithium battery and a rechargeable lithium battery including the same. A sheet for a rechargeable lithium battery includes a tape including an adhesive surface on a first surface and a non-adhesive surface or an adhesive surface on a second surface; and a coating layer located on the second surface of the tape and including a metal organic framework.

### TECHNICAL FIELD

### Background Art

### 1. Field

A sheet for a rechargeable lithium battery and a rechargeable lithium battery including the same are disclosed.

### 2. Description of the Related Art

Rechargeable lithium batteries are in the spotlight as power sources for driving medium to large devices such as hybrid vehicles and battery vehicles as well as small devices such as mobile phones, notebook computers, and smart phones.

When these rechargeable lithium batteries are exposed to misuse conditions such as overcharging and the like and extreme conditions such as heat exposure and the like, while thermal runaway occurs, since an amount of gas generated thereinside and thus sharply increases, the rechargeable lithium batteries may explode.

A method of reducing the amount of generated gas by coating the surface of an active material or by adding a film-forming additive to an electrolyte is known to some extent. However, the method is no longer effective, when the rechargeable lithium batteries enter a thermal runaway situation due to a short circuit.

### DISCLOSURE

### Technical Problem

An embodiment is to suppress a rapid increase of an amount of gas generated in a rechargeable lithium battery when it enters a thermal runaway situation.

### Technical Solution

In an embodiment, a sheet for a rechargeable lithium battery includes a tape including an adhesive surface on a first surface and a non-adhesive surface or an adhesive surface on a second surface; and a coating layer located on the second surface of the tape and including a metal organic framework (MOF).

Another embodiment provides a rechargeable lithium battery including the sheet for a rechargeable lithium battery.

### Advantageous Effects

In the sheet for a rechargeable lithium battery of the embodiment, the metal organic framework is a material capable of effectively trapping gas through an adsorption reaction.

Accordingly, a rechargeable lithium battery including the sheet for a rechargeable lithium battery has a significantly reduced risk of explosion even when a thermal runaway situation is entered and the amount of gas generated inside thereof rapidly increases, as the metal-organic framework captures the rapidly increasing gas.

### DESCRIPTION OF THE DRAWINGS

FIG. 1 illustrates various examples of shapes (patterns) of a coating layer formed according to an embodiment.

FIG. 2 is a perspective view of a pouch type rechargeable battery according to an embodiment.

FIG. 3 is a vertical cross-sectional view taken along line I-I in FIG. 2 in the direction of the arrow.

FIG. 4 is a horizontal cross-sectional view taken along line II-II in FIG. 2 in the direction of the arrow.

FIG. 5 schematically illustrates a position where a sheet for a rechargeable lithium battery can be inserted according to an embodiment.

FIG. 6 schematically illustrates a location where a sheet and an additional separator can be inserted for a rechargeable lithium battery according to an embodiment.

FIG. 7 shows an evaluation of the amount of gas generated during formation charge and discharge of rechargeable lithium battery cells according to examples and comparative examples.

FIG. 8 shows an evaluation of the amount of gas generated during overcharge for the rechargeable lithium battery cells according to examples and comparative examples.

FIG. 9 shows an evaluation of the amount of gas generated when exposed to heat for the rechargeable lithium battery cells according to examples and comparative examples.

FIG. 10 shows an evaluation of the amount of gas generated according to the thickness and area of the coating layer during overcharge for the rechargeable lithium battery cells of examples.

FIG. 11 shows an evaluation of the amount of gas generated according to the thickness and area of the coating layer when exposed to heat for the rechargeable lithium battery cells according to examples.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

“Combination thereof” refers to a mixture, a laminate, a composite, a copolymer, an alloy, a blend, a reaction product, and the like of constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The “layer” includes not only a shape formed on the whole surface when viewed from a plan view, but also a shape formed on a partial surface.

The “particle diameter” or “average particle diameter” may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

The “thickness” may be measured through a photograph taken with a thickness meter or an optical microscope such as a scanning electron microscope. Additionally, the “area” may be measured through photographs taken with an optical microscope, such as a scanning electron microscope.

### (Sheet for Rechargeable Lithium Battery)

In an embodiment, a sheet for a rechargeable lithium battery includes a tape including an adhesive surface on a first surface and a non-adhesive surface or an adhesive surface on a second surface; and a coating layer located on the second surface of the tape and including a metal organic framework (MOF).

The single-sided (the second surface is a non-adhesive surface) or double-sided (the second surface is an adhesive surface) tape, on which the metal organic framework may not only be coated and also, which may be easily attached on other components without a dispersion solvent, may easily increase packing density of a rechargeable lithium battery.

Accordingly, the sheet for a rechargeable lithium battery of an embodiment may be easily manufactured through a process of coating the metal organic framework on the second surface of the tape, and the manufactured sheet may be inserted into a rechargeable lithium battery in a method of attaching it on other components.

The coating may include a series of processes of dispersing the metal organic framework in a solvent such as N-methyl-2-pyrrolidone and the like to prepare a dispersion solution, spraying the dispersion solution with an ultrasonic wave spray coater and the like onto the second surface of the tape, and drying the tape onto which the dispersion solution is sprayed.

The metal organic framework is a material capable of effectively trapping gas through an adsorption reaction. Accordingly, a rechargeable lithium battery including the sheet for a rechargeable lithium battery of the embodiment has a significantly reduced risk of explosion even when a thermal runaway situation is entered and the amount of gas generated therein rapidly increases, as the metal-organic framework captures the rapidly increasing gas.

Hereinafter, the sheet for a rechargeable lithium battery of the embodiment will be described in detail.

### Structure of Metal Organic Framework

The metal organic framework is a material in which clusters including metal ions or metals are connected by organic ligands, and is a type of coordination polymer. The metal organic framework has a cage that is an empty space therein by forming a three-dimensional structure. As a result, the metal organic framework may undergo an adsorption reaction through the cage and trap gas into the cage.

On the other hand, zeolite, which is a crystalline aluminum silicate mineral, has an inferior gas trapping effect, compared with the metal organic framework. The gas adsorption reaction is a reaction in which gas molecules are adsorbed on the surface of a cage inside the material structure. In general, the larger a specific surface area, the more gas molecules may be adsorbed. According to the results of several previous studies, which compare specific surface areas of zeolite and representative materials with the metal organic framework, the metal organic framework has been reported to have a larger specific surface area than that of the zeolite. Accordingly, the metal organic framework may have a larger surface area for gas adsorption than the zeolite. Particularly, in a rechargeable lithium battery using a nickel-based positive electrode active material including 90% or more of Ni as a positive electrode active material, the metal organic framework exhibits a very excellent gas trapping effect, but the zeolite exhibits a very inferior gas trapping effect. This fact is confirmed in evaluation examples described later.

Structural and compositional characteristics of the metal organic framework may be usefully utilized in formation charging and discharging and thermal runaway situations of a rechargeable lithium battery. Specifically, when the sheet for a rechargeable lithium battery according to an embodiment is disposed inside the rechargeable lithium battery, an increase in battery volume and an increase in internal pressure may be prevented by trapping gas generated inside the rechargeable lithium battery during the first cycle charge and discharge (i.e., formation charge and discharge). Furthermore, even when the rechargeable lithium battery enters a thermal runaway situation where a short circuit occurs due to overcharge, heat exposure, and the like, the metal organic framework may effectively collect gas rapidly increasing inside the rechargeable lithium battery, so that the rechargeable lithium battery may be significantly less likely exploded.

In particular, in the sheet for a rechargeable lithium battery of the embodiment, the metal organic framework may include ZIF-8, MOF-177, AI-MIL-53, HKUST-1, Fe-BTC, or a combination thereof, and each structure is as follows:

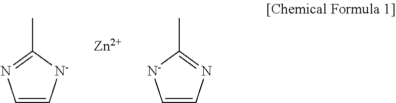

The ZIF-8 is represented by Chemical Formula 1, the coordination metal is Zn, and the linker is 2-methylimidazole. The ZIF-8 has a pore volume of 0.66 cm³/g and a BET specific surface area of 1300 to 1800 m²/g.

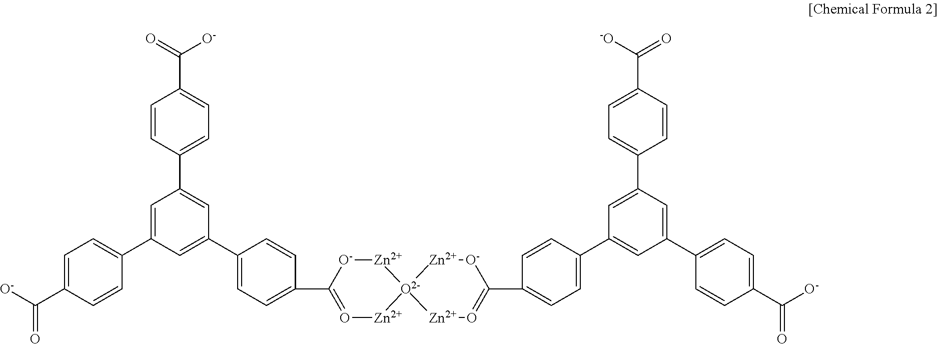

The MOF-177 is represented by Chemical Formula 2, the coordination metal is Zn, and the linker is H3BTB. The MOF-177 has a pore volume of 1.6 g/cm³ and a BET specific surface area of 3800 to 4000 m²/g.

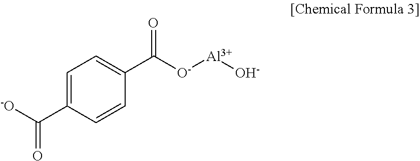

The AI-MIL-53 is represented by Chemical Formula 3, the coordination metal is Al, and the linker is terephthalic acid. The HKUST-1 has a pore volume of 0.7 g/cm³ and a BET specific surface area of 1100 to 1500 m²/g.

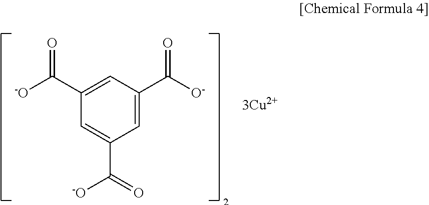

The HKUST-1, also known as Cu-BTC, is represented by Chemical Formula 4, the coordination metal is Cu and the linker is 1,3,5-benzenetricarboxylic acid. The HKUST-1 has a pore volume of 0.33 g/cm³ and a BET specific surface area of 1500 to 2100 m²/g.

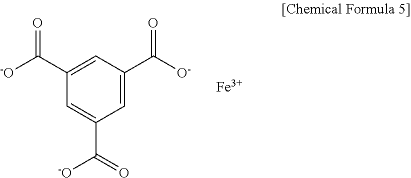

The Fe-BTC is represented by Chemical Formula 5, the coordination metal is Fe, and the linker is 1,3,5-benzenetricarboxylic acid. The Fe-BTC has a pore volume of 0.9 g/cm³ and a BET specific surface area of 1300 to 1600 m²/g.

In this regard, it is presumed that the gas capture effects of the ZIF-8, MOF-177, AI-MIL-53, HKUST-1, and Fe-BTC are significantly superior to those of not only zeolites but also other metal organic frameworks because the synergistic effects of physical adsorption and chemical adsorption for gas components (e.g., H₂, CO, CO₂, etc.) generated from rechargeable lithium batteries are maximized due to the molecular structure.

### Thickness and Area of Coating Layer

A thickness ratio of the coating layer to the tape (coating layer thickness/tape thickness) may be 1/5000 to 60. For example, the thickness ratio of the coating layer for the tape (coating layer thickness/tape thickness) may be greater than or equal to 1/5000, greater than or equal to 1/1000, greater than or equal to 1/100, greater than or equal to 1/10, or greater than or equal to 1 and less than or equal to 60.

Specifically, the coating layer may have a thickness of greater than or equal to 10 nm. For example, the thickness of the coating layer may be greater than or equal to 100 nm, greater than or equal to 10 nm, or greater than or equal to 1 μm and less than or equal to 5 mm or less than or equal to 3.25 mm.

While the coating layer to the tape has a thickness ratio (coating layer thickness/tape thickness) of less than 1/5000, when the coating layer has a thickness of less than 10 nm, there may be an insignificant effect of capturing gas by the metal organic framework. In contrast, while the thickness ratio (coating layer thickness/tape thickness) of the coating layer to the tape is greater than 60, the coating layer has a thickness of greater than 5 mm, packing density of the rechargeable lithium battery may be lowered.

Specifically, the area of the coating layer, which is an area (mm²) per unit capacity (1 mAh) of the rechargeable lithium battery, may be greater than or equal to 0.1 mm² mAh⁻¹. For example, the area of the coating layer may be greater than or equal to 0.1 mm² mAh⁻¹, greater than or equal to 0.9 mm² mAh⁻¹, or greater than or equal to 900 mm² mAh⁻¹ and less than or equal to 1000 mm² mAh⁻¹ less than or equal to 950 mm² mAh⁻¹, or less than or equal to 904 mm² mAh⁻¹.

If the area of the coating layer, which is an area (mm²) per unit capacity (1 mAh) of the rechargeable lithium battery, is less than 0.1 mm² mAh⁻¹, there may be an insignificant effect of capturing gas by the metal organic framework. Alternatively, if the coating layer has a thickness of greater than 1000 mm² mAh⁻¹, packing density of the rechargeable lithium battery may be lowered.

For reference, the “thickness” may be measured through a photograph taken with a thickness meter or a scanning electron microscope such as an optical microscope and the like. For example, the thickness of the coating layer in the sheet may be measured by cutting the sheet in a thickness direction and measuring a length between the lowest and the highest ends of the coating layer with a commercially available thickness meter. Alternatively, after taking an image of the cut surface by using an optical microscope such as a scanning electron microscope and the like, the length between the lowest and the highest ends of the coating layer shown on the image may be calculated to obtain the thickness of the coating layer.

On the other hand, an area of the coating layer in the sheet may be measured by taking an image of the sheet from the top with the optical microscope such as a scanning electron microscope and the like and calculating the area of the coating layer shown on the image.

In addition, the area of the coating layer, which an area (mm²) per unit capacity (1 mAh) of the rechargeable lithium battery, may be obtained by dividing the area (mm²) calculated as above by total capacity (mAh) of the rechargeable lithium battery.

### Shape (Pattern) of Coating Layer

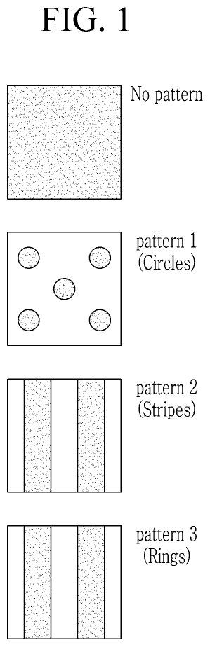

The coating layer may be patterned. In this way, the gas diffusion area is expanded in the patterned coating layer, and thus the gas capture effect can be further enhanced. Specifically, FIG. 1 illustrates various examples of shapes (patterns) of a coating layer formed according to an embodiment. The coating layer may be patterned into a plurality of circles, stripes, rings, or a combination thereof. However, the embodiment is not limited thereto and may include a non-patterned coating layer, in which case excellent gas capture effects may also be exhibited.

### Method for Forming Coating Layer

Any method that may be used in the relevant technical field may be used to form the coating layer.

Specifically, a slurry-phase coating solution may be prepared by dispersing the metal organic framework, which is ZIF-8, MOF-177, AI-MIL-53, HKUST-1, Fe-BTC, or a combination thereof, in an appropriate dispersion solvent. Then, the sheet may be completed by coating the coating solution on the substrate and then going through a drying process, etc. As the dispersion solvent, N-methyl-2-pyrrolidone (NMP) may be used, and as the application method, spray coating may be used, but is not limited thereto, and materials and methods widely known in the art may be used.

Meanwhile, because the sheet uses a tape that includes an adhesive surface on at least one surface, a coating layer can be formed simply by coating a solution including the metal organic framework on the adhesive surface of the tape and then drying it, without a separate binder.

### Structure and Material of Tape

The tape may be a single-sided tape having a substrate layer and a first adhesive layer on the first surface of the substrate layer. Unlike this, the tape may be a double-sided adhesive tape having the substrate layer; the first adhesive layer on the first surface of the substrate layer; and a second adhesive layer on the second surface of the substrate layer. The latter, in which the metal organic framework may be coated without a separate binder, may easily increase packing density of a rechargeable lithium battery.

The substrate layer, which may include polypropylene, may buffer a pressure formed as each electrode expands and shrinks during the charge and discharge of the rechargeable lithium battery.

The first adhesive layer and the second adhesive layer of the tape may independently include an acrylic polymer, an urethane-based polymer, or a combination thereof, through which the sheet for a rechargeable lithium battery according to an embodiment may be effectively adhered onto other components.

### (Rechargeable Lithium Battery)

In another embodiment, a rechargeable lithium battery is provided including the sheet for a rechargeable lithium battery of the aforementioned embodiment.

A rechargeable lithium battery including the sheet for a rechargeable lithium battery of the above embodiment has a significantly reduced risk of explosion, as the metal-organic framework captures the rapidly increasing gas even when the rechargeable lithium battery enters a thermal runaway situation and the amount of gas generated therein rapidly increases.

Hereinafter, the rechargeable lithium battery is described in detail, excluding any explanation that overlaps with the above-mentioned contents.

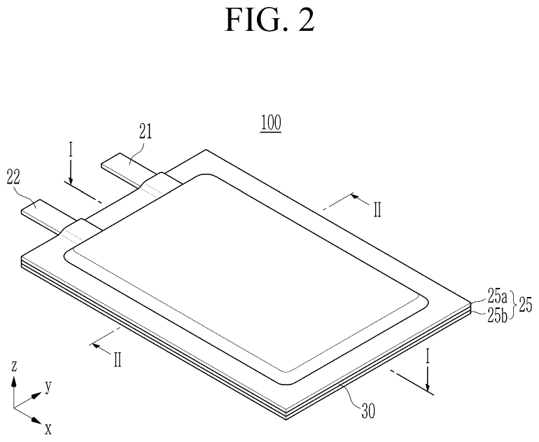

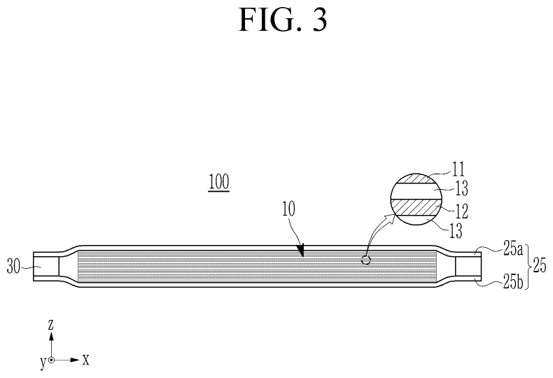

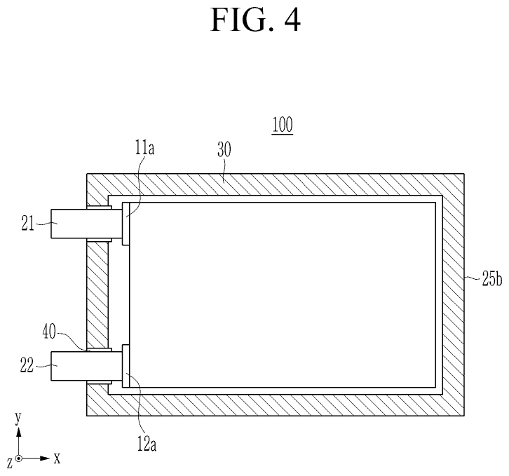

FIG. 2 is a perspective view of a pouch type rechargeable battery according to an embodiment, FIG. 3 is a vertical cross-sectional view taken along line I-I in FIG. 2 in the direction of the arrow, and FIG. 4 is a horizontal cross-sectional view taken along line II-II in FIG. 2 in the direction of the arrow. Herein, a rechargeable lithium battery according to an embodiment is described as an example in which a stack type electrode assembly is mounted in a pouch type case, but the present invention is not limited thereto, and may be applied to a battery in which an electrode assembly of a stack type, a winding type (jelly-roll type), a stack and folding type, a Z-folding type, etc. is mounted in a case of a cylindrical, prismatic, coin shape, etc.

Referring to FIGS. 2 to 4, a pouch type secondary battery 100 according to an embodiment includes an electrode assembly 10 having a separator 13 between a positive electrode 11 and a negative electrode 12, an exterior material 25 in which the electrode assembly 10 is housed, and a positive electrode terminal 21 electrically connected to the positive electrode 11, and a negative electrode terminal 22 electrically connected to the negative electrode 12.

Meanwhile, the electrode assembly 10 may have a structure in which a plurality of positive electrodes 11 and a plurality of negative electrodes 12 in the shape of square sheets are alternately stacked with a separator 13 interposed therebetween. An embodiment is not limited thereto, and may have a structure in which one positive electrode 11 and one negative electrode 12 are stacked with one separator 13 interposed therebetween. Additionally, the electrode assembly may be formed into a structure in which a separator is interposed between a band-shaped positive electrode and negative electrode and then wound.

In the electrode assembly 10, a positive electrode uncoated region 11a and a negative electrode uncoated region 12a are disposed at one end, and a positive electrode terminal 21 is attached by welding to the positive electrode uncoated region 11a, and a negative electrode terminal 22 is attached by welding to the negative electrode uncoated region 12a.

The positive electrode 11, negative electrode 12, and separator 13 may each be formed in a square sheet shape. The electrode assembly 10 may be housed inside the exterior material 25 and sealed by a sealing portion 30 along the edge of the exterior material 25, but is not limited thereto.

The exterior material 25 may include an upper exterior material 25a and a lower exterior material 25b. The upper exterior material 25a and the lower exterior material 25b may each have a multilayer structure. The structures of the upper exterior material 25a and the lower exterior material 25b are the same, and will be explained as an example based on the upper exterior material 25a. The upper exterior material 25a may have a configuration in which an outer resin layer, a metal layer, and an inner resin layer are sequentially stacked.

The sealing portion 30 may be located at the edge of the exterior material 25, as shown in FIG. 3, but is not limited thereto. An insulating member 40 may be attached to each of the positive electrode terminal 21 and the negative electrode terminal 22, but is not limited thereto.

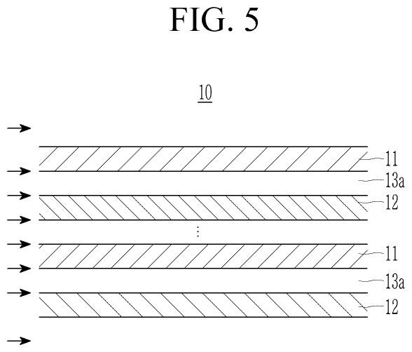

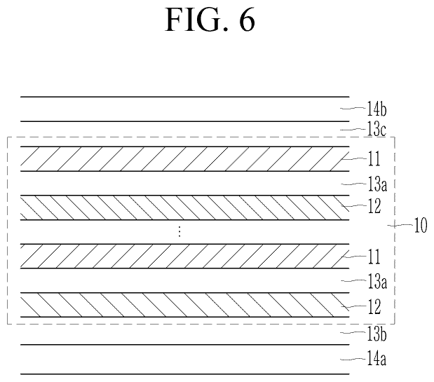

Meanwhile, FIG. 5 schematically illustrates a position where a sheet for a rechargeable lithium battery according to an embodiment can be inserted. In addition, FIG. 6 schematically illustrates a location where a sheet and an additional separator for a rechargeable lithium battery according to an embodiment can be inserted.

As shown in FIGS. 5 and 6, the rechargeable lithium battery includes the assembly 10 in which the negative electrode 12; the first separator 13a; and the positive electrode 11 are sequentially stacked, and the sheet for a rechargeable lithium battery 14 according to an embodiment may be inserted onto an appropriate position inside or outside of the assembly 10.

Specifically, as shown in FIG. 5, the sheet for a rechargeable lithium battery 14 may be inserted onto the outer surface of the assembly at the negative electrode side; onto an outer surface of the assembly at the positive electrode side; between the positive electrode and the first separator; or between the negative electrode and the first separator. In FIG. 5, the position where the sheet for a rechargeable lithium battery 14 is inserted is marked as an arrow (“→”).

Specifically, as shown in FIG. 6, the rechargeable lithium battery includes the assembly 10 in which the negative electrode 12; the first separator 13a; and the positive electrode 11 are sequentially stacked, and additional separators 14b and 14c as well as the sheets 14a and 14b for a rechargeable lithium battery may be inserted inside and outside of the assembly 10. Herein, the rechargeable lithium battery may include the first sheet 14a for a rechargeable lithium battery and the second sheet 14b for a rechargeable lithium battery respectively on the outer surface of the negative electrode 12 of the assembly 10; and on the outer surface of the positive electrode 11 of the assembly. In addition, the rechargeable lithium battery may further include a second separator 13b between the outer surface of the assembly 10 at the negative electrode 12 side and the first sheet 14a for a rechargeable lithium battery. Independently from this, the rechargeable lithium battery may further include a third separator 13c between the outer surface of the assembly 10 at the positive electrode 11 side and the second sheet 14b for a rechargeable lithium battery. In such a structure, as the rechargeable lithium battery according to an embodiment enters a thermal runaway situation, even if a gas generation amount rapidly increases, the metal organic framework may capture the rapidly-increasing gas on the outmost surface, resultantly suppressing heat emission out of the assembly and significantly lowering a risk of explosion.

### Positive Electrode

The positive electrode includes a current collector and a positive electrode active material layer on the current collector.

The positive electrode active material layer includes a positive electrode active material and may further include a binder and/or a conductive material.

As the positive electrode active material, a compound capable of reversible intercalation and deintercalation of lithium (a lithiated intercalation compound) may be used. Examples of the positive electrode active material include a compound represented by any one of the following formulas:

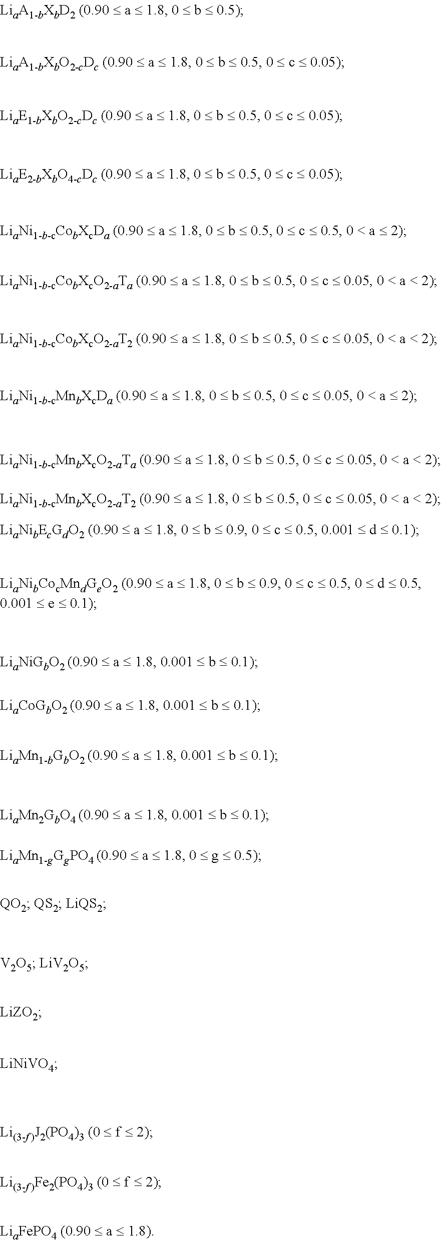

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may use a method that does not adversely affect the physical properties of the positive electrode active material, for example, spray coating, dipping, and the like.

For example, the positive electrode may include a composite oxide of lithium and at least one metal selected from nickel, cobalt, manganese, and aluminum as a positive electrode active material.

The positive electrode active material may include, for example, a lithium nickel composite oxide represented by Chemical Formula 11.

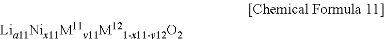

In Chemical Formula 11, 0.9≤a11≤1.8, 0.3≤x11≤1, 0≤y11≤0.7, and M¹¹ and M¹² are independently are selected from Al, B, Ce, Co, Cr, F, Mg, Mn, Mo, Nb, P, S, Si, Sr, Ti, V, W, Zr, and a combination thereof.

In Chemical Formula 11, 0.4≤x11≤1 and 0≤y11≤0.6; 0.5≤x11≤1 and 0≤y11≤0.5; 0.6≤x11≤1 and 0≤y11≤0.4; 0.7≤x11≤1 and 0≤y11≤0.3; 0.8≤x11≤1 and 0≤y11≤0.2; or 0.9≤x11≤1 and 0≤y11≤0.1.

As a specific example, the second positive electrode active material may include a lithium nickel cobalt composite oxide represented by Chemical Formula 12.

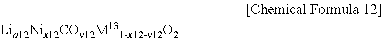

In Chemical Formula 12, 0.9≤a12≤1.8, 0.3≤x12<1, 0<y12≤0.7, and M¹³ is selected from Al, B, Ce, Cr, F, Mg, Mn, Mo, Nb, P, S, Si, Sr, Ti, V, W, Zr, and a combination thereof.

In Chemical Formula 12, 0.3≤x12≤0.99 and 0.01≤y12≤0.7; 0.4≤x12≤0.99 and 0.01≤y12≤0.6; 0.5≤x12≤0.99 and 0.01≤y12≤0.5; 0.6≤x12≤0.99 and 0.01≤y12≤0.4; 0.7≤x12≤0.99 and 0.01≤y12≤0.3; 0.8≤x12≤0.99 and 0.01≤y12≤0.2 or 0.9≤x12≤0.99 and 0.01≤y12≤0.1.

As a specific example, the positive electrode active material may include a lithium nickel cobalt composite oxide represented by Chemical Formula 13.

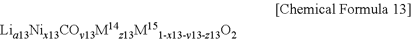

In Chemical Formula 13, 0.9≤a13≤1.8, 0.3≤x13≤0.98, 0.01≤y13≤0.69, 0.01≤z13≤0.69, M¹⁴ is selected from Al, Mn, and a combination thereof, and M¹⁵ is selected from B, Ce, Cr, F, Mg, Mo, Nb, P, S, Si, Sr, Ti, V, W, Zr, and a combination thereof.

In Chemical Formula 13, 0.4≤x13≤0.98, 0.01≤y13≤0.59, and 0.01≤z13≤0.59; 0.5≤x13≤0.98, 0.01≤y13≤0.49, and 0.01≤z13≤0.49; 0.6≤x13≤0.98, 0.01≤y13≤0.39, and 0.01≤z13≤0.39; 0.7≤x13≤0.98, 0.01≤y13≤0.29, and 0.01≤z13≤0.29; 0.8≤x13≤0.98, 0.01≤y13≤0.19, and 0.01≤z13≤0.19; or 0.9≤x13≤0.98, 0.01≤y13≤0.09, and 0.01≤z13≤0.09.

For more specific examples, an LCO-based positive electrode active material, a high-Ni NCA-based positive electrode active material, or a combination thereof (representatively, LiCoO₂, LiNi_{0.91}Co_{0.07}Al_{0.02}O₂, LiNi_{0.82}Co_{0.11}Mn_{0.07}O₂, or a combination thereof) may be used as the positive electrode active material.

A content of the positive electrode active material may be 85 wt % to 99 wt %, for example 90 wt % to 95 wt % based on a total weight of the positive electrode active material layer. Each content of the binder and the conductive material may be 1 wt % to 5 wt % based on a total weight of the positive electrode active material layer.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, carbon fiber, carbon nanotube, and the like; a metal-based material of a metal powder or a metal fiber, and the like including copper, nickel, aluminum silver, and the like; a conductive polymer such as a polyphenylene derivative; or a mixture thereof.

An aluminum foil may be used as the positive electrode current collector, but is not limited thereto.

### Negative Electrode

The negative electrode for a rechargeable lithium battery includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping and dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

Meanwhile, the negative electrode may include a carbon-based negative electrode active material, a silicon-based negative electrode active material, or a combination thereof as a negative electrode active material.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on a total weight of the silicon-carbon composite. In addition, the content of the crystalline carbon may be 10 wt % to 70 wt % based on a total weight of the silicon-carbon composite, and the content of the amorphous carbon may be 20 wt % to 40 wt % based on a total weight of the silicon-carbon composite. In addition, a thickness of the amorphous carbon coating layer may be 5 nm to 100 nm. An average particle diameter (D50) of the silicon particles may be 10 nm to 20 μm. The average particle diameter (D50) of the silicon particles may be preferably 10 nm to 200 nm. The silicon particles may exist in an oxidized form, and in this case, an atomic content ratio of Si:O in the silicon particles indicating a degree of oxidation may be a weight ratio of 99:1 to 33:66. The silicon particles may be SiOₓ particles, and in this case, the range of x in SiOₓ may be greater than 0 and less than 2. In the present specification, unless otherwise defined, an average particle diameter (D50) indicates a diameter of particles having a cumulative volume of 50 volume % in the particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio of 1:99 to 90:10.

In the negative electrode active material layer, the negative electrode active material may be included in an amount of 50 wt % to 99 wt % based on a total weight of the negative electrode active material layer.

In an embodiment, the negative electrode active material layer further includes a binder, and may optionally further include a conductive material. The content of the binder in the negative electrode active material layer may be 1 wt % to 5 wt % based on a total weight of the negative electrode active material layer. In addition, when further including a conductive material, the negative electrode active material layer may include 50 to 99 wt % of the negative electrode active material, 1 to 5 wt % of the binder, and 1 to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. As the alkali metal, Na, K or Li may be used. The amount of the thickener used may be 0.1 parts by weight to 3 parts by weight based on 100 parts by weight of the negative electrode active material.

The conductive material is included to provide electrode conductivity. Any electrically conductive material may be used as a conductive material unless it causes a chemical change in a battery. Examples of the conductive material include a carbon-based material such as natural graphite, artificial graphite, carbon black, acetylene black, ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Separator

The separator separates a positive electrode and a negative electrode and provides a transporting passage for lithium ions and may be any generally-used separator in a lithium ion battery. In other words, it may have low resistance to ion transport and excellent impregnation for an electrolyte. For example, separator may be selected from a glass fiber, polyester, TEFLON, polyethylene, polypropylene, polytetrafluoroethylene, or a combination thereof. It may have a form of a non-woven fabric or a woven fabric.

In order to secure heat resistance or mechanical strength, a separator coated with inorganic filler particles and/or an adhesive in a single-layer or multilayer structure may be used.

Specifically, the coating layer of the separator may further include inorganic filler particles. The inorganic filler particles may be a metal oxide, a semi-metal oxide, or a combination thereof. Specifically, the inorganic filler particles may be one or more selected from alumina (Al₂O₃), boehmite, BaSO₄, MgO, Mg(OH)₂, clay, silica (SiO₂), and (TiO₂). The alumina, silica, and the like have a small particle size, and thus it is easy to make a dispersion.

For example, the inorganic filler particles may be Al₂O₃, SiO₂, TiO₂, SnO₂, CeO₂, NiO, CaO, ZnO, MgO, ZrO₂, Y₂O₃, SrTiO₃, BaTiO₃, MgF₂, Mg(OH)₂, or a combination thereof. The inorganic filler particles may have a sphere, plate shape, fiber shape, etc., but are not limited thereto, and any form usable in the art may be used.

The plate-shaped inorganic filler particles include, for example, alumina and boehmite. In this case, a reduction in the area of the separator at a high temperature may be further suppressed, a relatively large degree of porosity may be secured, and characteristics may be improved when evaluating the penetration of a lithium battery.

When the inorganic filler particles are sheet-shaped or fiber-shaped, the inorganic filler particles may have an aspect ratio of about 1:5 to 1:100. For example, the aspect ratio may be about 1:10 to 1:100. For example, the aspect ratio may be about 1:5 to 1:50. For example, the aspect ratio may be about 1:10 to 1:50.

The sheet-shaped inorganic filler particles may have a length ratio of a major axis to a minor axis of 1 to 3 on a planar surface. For example, the length ratio of a major axis to a minor axis on the planar surface may be 1 to 2. For example, the length ratio of a major axis to a minor axis on the planar surface may be about 1. The aspect ratio and the length ratio of a major axis to a minor axis may be measured through a scanning electron microscope (SEM). Within the aspect ratio range and the length ratio range of a major axis to a minor axis, a separator may be suppressed from contraction, securing relatively improved porosity may be secured and improving penetration characteristics of a lithium battery.

When the inorganic filler particles are plate-shaped, a planar surface of the inorganic filler particles with one surface of a porous substrate has an average angle of 0° to 30°. For example, the average angle of the planar surface of the inorganic filler particles with one surface of a porous substrate may be converged to 0°. In other words, the planar surface of the inorganic filler particles may be parallel with one surface of a porous substrate. For example, when the average angle of the planar surface of the inorganic filler particles with one surface of a porous substrate is within the ranges, the porous substrate may be effectively suppressed from thermal contraction, providing a separator with a reduced contraction rate.

On the other hand, the coating layer of the separator may include a particle type or solution type polymer adhesive as an adhesive. Examples of the polymer adhesive may include polyvinylidene fluoride (PVdF), a polyvinylidene fluoride-hexafluoropropylene (PVdF-HFP) copolymer, or a combination thereof. When a separator prepared by coating the polymer adhesive at least one surface of the substrate is used, the polymer adhesive is physically cross-linked with binders respectively present in the positive electrode and the negative electrode, improving adherence between the separator and the electrodes.

The coating layer may have thickness of 1 μm to 10 μm and specifically, 1 to 8 μm. The coating layer having a thickness within the ranges may secure excellent heat resistance and in addition, suppress thermal contraction and elution of metal ions.

### Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like and the ketone-based solvent may be cyclohexanone, and the like. In addition, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and the like.

The non-aqueous organic solvent may be used alone or in a mixture. When the organic solvent is used in a mixture, the mixture ratio may be controlled in accordance with a desirable battery performance.

In addition, in the case of the carbonate-based solvent, a mixture of a cyclic carbonate and a chain carbonate may be used. In this case, when the cyclic carbonate and the chain carbonate are mixed in a volume ratio of about 1:1 to 1:9, the electrolyte may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

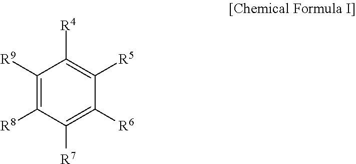

In Chemical Formula I, R⁴ to R⁹ are the same or different and are selected from hydrogen, a halogen, a C1 to C10 alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound of Chemical Formula II in order to improve cycle-life of a battery.

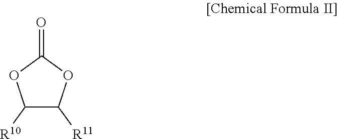

In Chemical Formula II, R¹⁰ and R¹¹ are the same or different, and are selected from hydrogen, a halogen, a cyano group, a nitro group, and fluorinated C1 to C5 alkyl group, provided that at least one of R¹⁰ and R¹¹ is selected from a halogen, a cyano group, a nitro group, and fluorinated C1 to C5 alkyl group, but both of R¹⁰ and R¹¹ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlCl₄, LiPO₂F₂, LiN(CₓF₂ₓ₊₁SO₂)(CyF_{2y+1}SO₂), wherein x and y are natural numbers, for example, an integer ranging from 1 to 20, lithium difluoro(bisoxolato)phosphate, LiCl, Lil, LiB(C₂O₄)₂ (lithium bis(oxalato) borate: LiBOB), and lithium difluoro(oxalato)borate (LiDFOB).

The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Meanwhile, as an additive of the electrolyte, other additives may be further included in addition to the aforementioned compound.

The other additives may include at least one of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), propensultone (PST), propanesultone (PS), lithium tetrafluoroborate (LiBF₄), lithium difluorophosphate (LiPO₂F₂), and 2-fluorobiphenyl (2-FBP).

By further including the aforementioned other additives, cycle-life may be further improved, or gases generated from the positive electrode and the negative electrode may be effectively controlled when stored at a high temperature.

The other additives may be included in an amount of 0.2 to 20 parts by weight, specifically 0.2 to 15 parts by weight, for example, 0.2 to 10 parts by weight, based on 100 parts by weight of the electrolyte for a rechargeable lithium battery.

When the content of other additives is as described above, the increase in film resistance may be minimized, thereby contributing to the improvement of battery performance.

Rechargeable lithium batteries may be classified as lithium ion batteries, lithium ion polymer batteries, and lithium polymer batteries according to the presence of a separator and the type of electrolyte used therein. The rechargeable lithium batteries may have a variety of shapes and sizes, and include cylindrical, prismatic, coin, or pouch type batteries, and may be thin film batteries or may be rather bulky in size. Since the structure and manufacturing method of these batteries are well known in the art, a detailed description thereof will be omitted.

### MODE FOR INVENTION

Hereinafter, examples of the present invention and comparative examples are described. It is to be understood, however, that the examples are for the purpose of illustration and are not to be construed as limiting the present invention.

### Example 1

### (1) Manufacturing of Sheet for Rechargeable Lithium Battery

A single-sided tape including polypropylene as a substrate layer and an adhesive layer formed on the first surface of the substrate layer and having a size of width*length*thickness=33.5 mm*27 mm*0.054 mm (product name: OPP tape, manufacturer: Tapex) was prepared.

On the second surface of the single-sided tape, ZIF-8 was coated to form a coating layer. The coating layer was formed by dispersing ZIF-8 in N-methyl-2-pyrrolidone (NMP) to prepare a ZIF-8 dispersion solution, spraying the ZIF-8 dispersion solution with an ultrasonic wave spray coater (SRC-300 U, E-Flex) on the second surface of the cross-section tape, and drying it at 85° C. Herein, the coating layer was formed on the entire second surface of the tape so that the tape had a thickness ratio (coating layer thickness/tape thickness) of 10. Specifically, the coating layer had a thickness of 1 mm, and its area, which is an area (mm²) per unit capacity (1 mAh) of a rechargeable lithium battery, was 904 mm² mAh⁻¹.

This method was used to manufacture two sheets for a rechargeable lithium battery, which was respectively called to be a first sheet for a rechargeable lithium battery and a second sheet for a rechargeable lithium battery.

### (2) Manufacturing of Negative Electrode

A negative electrode active material slurry was prepared by mixing 70 wt % of a negative electrode active material of artificial graphite (D50: 16.6 μm) and silicon (D50: 18.0 μm) in a weight ratio of 9:1, 15 wt % of a conductive material (Super-P), and 15 wt % of a binder (PAA (Poly Acrylic acid)) in water as a solvent. The negative electrode active material slurry was coated to a thickness of 140 μm on one surface of a copper foil having a thickness of 10 μm, dried, and compressed to manufacture a negative electrode having a total thickness of 120 μm. Herein, die coating was used as the method for coating the negative electrode active material slurry. After coating, it was first dried for 1 hour in an air atmosphere at 60° C., and then dried for 12 hours under vacuum conditions at 110° C. The dried negative electrode plate was cut into a size of 2.2×3.2 cm².

### (3) Manufacturing of Positive Electrode

A positive electrode active material was prepared by mixing 95 wt % of LiNi_{0.91}Co_{0.07}Al_{0.02}O₂ as a positive electrode active material, 3 wt % of polyvinylidene fluoride as a binder, and 2 wt % of ketjen black as a conductive material in an N-methylpyrrolidone solvent. This was coated on one surface of an aluminum current collector having a thickness of 12 μm to a thickness of 164 μm, dried, and compressed to manufacture a positive electrode active material layer having a total thickness of 138 μm. Herein, die coating was used as the method for coating the positive electrode active material slurry. After coating, it was first dried for 1 hour in an air atmosphere at 80° C., and vacuum-dried for 12 hours in a vacuum condition at 120° C. The dried positive electrode plate was cut into cut into a size of 2×3 cm².

### (4) Manufacturing of Battery Cell

Three polyethylene/polypropylene/polyethylene separators with a thickness of 14 μm were prepared and then, referred to as a first separator, a second separator, and a third separator.

First, the first separator was inserted between the negative electrode and the positive electrode. Herein, the inner surface (active material layer) of each electrode was in contact with the first separator.

Additionally, the second separator and the first sheet for a rechargeable lithium battery were sequentially stacked on the outer surface of the negative electrode, and the third separator and the second the sheet for a rechargeable lithium battery were stacked on the outer surface of the positive electrode.

Accordingly, an electrode assembly having a structure of (first sheet for a rechargeable lithium battery)/(second separator)/(negative electrode)/(first separator)/(positive electrode)/(third separator)/(second sheet for a rechargeable lithium battery) was completed.

After inserting the electrode assembly into a pouch, an electrolyte prepared by mixing ethylene carbonate and diethyl carbonate in a volume ratio of 30:70 and adding 1.5 M of LiPF₆ lithium salt and 12.5 wt % of FEC thereto was injected thereinto to manufacture a rechargeable lithium battery cell.

### Example 2

In manufacturing the sheet for a rechargeable lithium battery, MOF-177 was used instead of ZIF-8. Except for this, a sheet for a rechargeable lithium battery and a rechargeable lithium battery cell of Example 2 were manufactured in the same manner as in Example 1.

### Example 3

In manufacturing the sheet for a rechargeable lithium battery, AI-MIL-177 was used instead of ZIF-8. Except for this, a sheet for a rechargeable lithium battery and a rechargeable lithium battery cell of Example 3 were manufactured in the same manner as in Example 1.

### Example 4

In manufacturing the sheet for a rechargeable lithium battery, HKUST-1 was used instead of ZIF-8. Except for this, a sheet for a rechargeable lithium battery and a rechargeable lithium battery cell of Example 4 were manufactured in the same manner as in Example 1.

### Example 5

In manufacturing the sheet for a rechargeable lithium battery, Fe-BTC was used instead of ZIF-8. Except for this, a sheet for a rechargeable lithium battery and a rechargeable lithium battery cell of Example 5 were manufactured in the same manner as in Example 1.

### Example 6

In manufacturing the sheet for a rechargeable lithium battery, a coating layer was formed so that the thickness ratio of the coating layer to the tape (coating layer thickness/tape thickness) was 1/5000. Specifically, the coating layer had a thickness of 10 nm. Except for this, a sheet for a rechargeable lithium battery and a rechargeable lithium battery cell of Example 6 were manufactured in the same manner as in Example 1.

### Example 7

In manufacturing the sheet for a rechargeable lithium battery, a coating layer was formed to have an area of 0.9 mm² mAh⁻ as an area (mm²) per unit capacity (1 mAh) of a rechargeable lithium battery cell. Except for this, a sheet for a rechargeable lithium battery and a rechargeable lithium battery cell of Example 7 were manufactured in the same manner as in Example 1.

### Example 8

In manufacturing the sheet for a rechargeable lithium battery, a coating layer tried to be formed to have 60 of a thickness ratio of the coating layer to the tape (coating layer thickness/tape thickness) but not to have a thickness of 3.25 mm or more.

### Comparative Example 1

A rechargeable lithium battery cell of Comparative Example 1 was manufactured in the same manner as in Example 1 except that the tape itself with no coating layer was used as a sheet for a rechargeable lithium battery.

### Comparative Example 2

In manufacturing the sheet for a rechargeable lithium battery, zeolite was used instead of ZIF-8. Except for this, a sheet for a rechargeable lithium battery and a rechargeable lithium battery cell of Comparative Example 2 were manufactured in the same manner as in Example 1.

### Comparative Example 3

When manufacturing sheets for rechargeable lithium batteries, a porous substrate made of PE material (manufacturer: Cellgard LLC.) was used instead of the tape. For reference, the porous substrate made of a PE material is in general used as a separator for a rechargeable lithium battery. Except for this, a sheet for a rechargeable lithium battery and a rechargeable lithium battery cell of Comparative Example 3 were manufactured in the same manner as in Example 1.

### Evaluation Example 1: Evaluation of Amount of Gas Generated During Charge and Discharge of Rechargeable Lithium Battery Cell

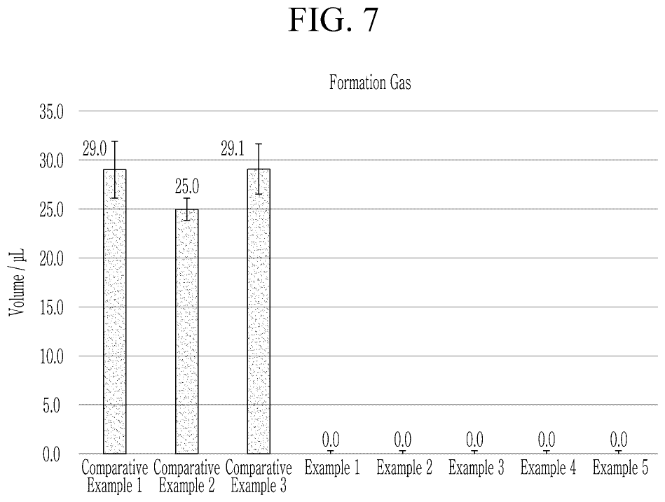

The rechargeable lithium battery cells of Examples 1 to 5 and Comparative Example 1 were respectively evaluated with respect to a gas generation amount during the formation charge and discharge, and the results are shown in FIG. 7.

Specifically, the formation charge and discharge of the rechargeable lithium battery cells was performed as one cycle under the following condition at 25° C. (room temperature).

Charge condition: CC (constant current)/CV(constant voltage), 4.2 V, 0.02 C current cut-off

Discharge condition: CC (constant current), 2.5 V

After completing the formation charge and discharge under the above condition, the gas generation amount was evaluated by extracting the rechargeable lithium battery cells with a syringe and then, injecting them into GC-MS.

Referring to FIG. 7, the rechargeable lithium battery cell of Comparative Example 1 generated 29.0 volume/ [symbol] of gas during the formation charge and discharge, but the rechargeable lithium battery cells of Examples 1 to 5 generated a very small gas generation amount during the formation charge and discharge.

Accordingly, the sheet for a rechargeable lithium battery according to an embodiment may be disposed inside a rechargeable lithium battery to effectively capture gas generated inside the rechargeable lithium battery during the first cycle of charge and discharge (i.e., formation charge and discharge) and thereby, prevent an increase in a volume and an internal pressure of the battery

### Evaluation Example 2: Evaluation of Amount of Gas Generated During Overcharging of Rechargeable Lithium Battery Cell

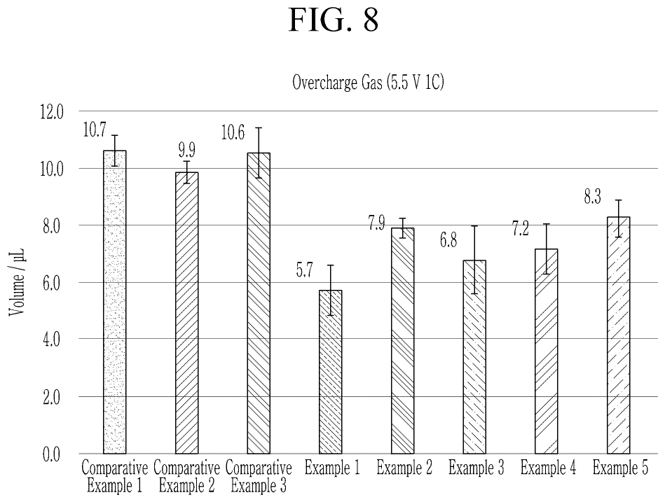

Each of the rechargeable lithium battery cells of Examples 1 to 5 and Comparative Examples 1 to 3 was evaluated with respect to a gas generation amount during the overcharge, and the results are shown in FIG. 8.

Specifically, the rechargeable lithium battery cells were overcharged at 25° C. (room temperature) for 5 hours under the following condition until their SOC (state of charge) reached 500%.

Charge condition: CC (constant current)/CV(constant voltage), 5.5 V, 1 C current cut-off

After completing the overcharge under the condition, the gas generation amount was evaluated in the same manner as in Evaluation Example 1.

Referring to FIG. 8, the rechargeable lithium battery cells of Comparative Examples 1 to 3 generated a gas amount of 9.9 volume/ft or more during the overcharge, but the rechargeable lithium battery cells of Examples 1 to 5 generated less than 80% of the gas generation amount of the rechargeable lithium battery cell of Comparative Example 1.

Accordingly, the sheet for a rechargeable lithium battery according to an embodiment may be disposed inside a rechargeable lithium battery to effectively capture gas generated inside the rechargeable lithium battery even during the overcharge and thereby, prevent an increase in a volume and an internal pressure of the battery.

On the other hand, among the rechargeable lithium battery cells of Examples 1 to 5, the rechargeable lithium battery cell of Example 1 using a sheet for a rechargeable lithium battery prepared by coating ZIF-8 exhibited a significantly small gas generation amount. According to MOF-related literature (Hasmukh A. Patel et. al., ChemSusChem 2017, 10, 1303 to 1317), cations such as zinc ions and the like are known to increase polarity and thus a reaction area for gas adsorption reaction, and anions such as imidazole skeletons and the like are known to provide unshared electron pairs and thus increase chemical adsorption of gas molecules. The gas molecules may be chemically absorbed by the cations/anions on the MOF pore surface and physically adsorbed in nonpolar regions such as carbon and the like, but as farther from the pore surface, the physical adsorption mainly occurs due to Van der Waals forces rather the chemical adsorption. Accordingly, three factors such as a binding force for gas molecules by cations/anions, a surface area of materials, and a size of pores should be maximized to maximize gas adsorption capacity. ZIF-8 has the greatest gas reduction effect, which was estimated to have a structure of maximizing the effect for gas components generated from a rechargeable lithium battery.

### Evaluation Example 3: Evaluation of Gas Generation Amount when Rechargeable Lithium Battery Cell is Exposed to Heat

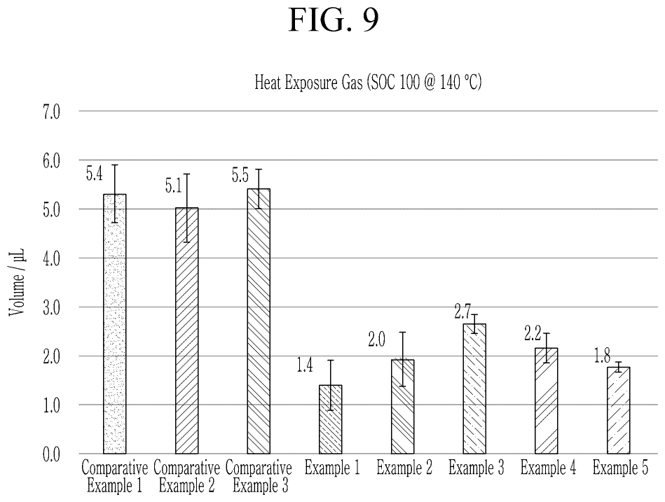

The rechargeable lithium battery cells according to Examples 1 to 5 and Comparative Examples 1 to 3 were respectively evaluated with a gas generation amount, when exposed to heat, and the results are shown in FIG. 9.

Specifically, the rechargeable lithium battery cells were respectively charged to 4.2 V and a current cut-off of 0.02 C and then, heated to 140° C. at 5° C./min and allowed to stand at 140° C. for 1 hours.

After completing the overcharge under the condition, the cells were evaluated with respect to the gas generation amount in the same manner as in Evaluation Example 1.

Referring to FIG. 9, the rechargeable lithium battery cells of Comparative Examples 1 to 3 generated gas of 5.1 volume/ft or more, when exposed to heat of 140° C., but the rechargeable lithium battery cells of Examples 1 to 5 generated less than 50% of the gas generated from the rechargeable lithium battery cell of Comparative Example 1, even when exposed to heat of 140° C.

Accordingly, the sheet for a rechargeable lithium battery according to an embodiment may be disposed inside a rechargeable lithium battery to effectively capture gas generated inside the rechargeable lithium battery, even when exposed to heat, and thus prevent an increase in a volume and an internal pressure of the battery.

On the other hand, among the rechargeable lithium battery cells of Examples 1 to 5, the cell of Example 1 using a sheet for a rechargeable lithium battery prepared by coating ZIF-8 exhibited a significantly small gas generation amount, which was consistent with the result of Evaluation Example 2.

### Evaluation Example 4: Evaluation of Amount of Gas Generated According to Thickness and Area of Coating Layer

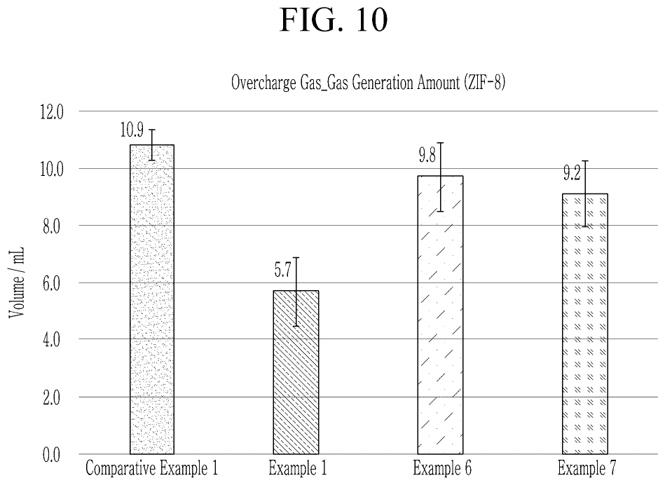

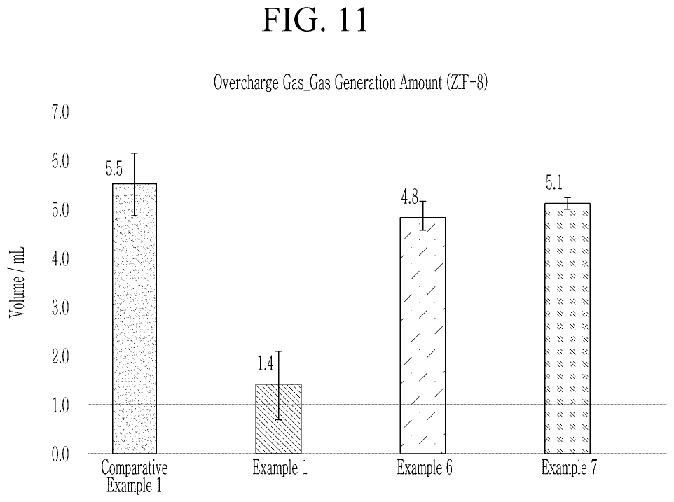

The rechargeable lithium battery cells of Examples 1, 6, and 7 and Comparative Example 1 were evaluated with respect to a gas generation amount, when overcharged and exposed to heat, and the results are respectively shown in FIG. 10 (overcharge) and FIG. 11 (exposed to heat).

Herein, the overcharge was performed under the same condition as in Evaluation Example 2, and the exposure to heat was performed under the same condition as in Evaluation Example 3, wherein the same methods of evaluating the gas generation amount as in Evaluation Examples 1 to 3 were used.

Referring to FIGS. 10 and 11, even if the same metal organic framework was used, the gas generation amount was changed depending on a thickness and an area of the coating layer on the tape, when overcharged and exposed to heat.

Accordingly, a thickness and an area of a coating layer may be adjusted to control a gas generation amount, when overcharged and exposed to heat.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

[Description of Symbols]

| | |
|---|---|
| 100: pouch type rechargeable battery | |
| 10: electrode assembly | |
| 11: positive electrode | 11a: positive electrode |
| | uncoated region |
| 12: negative electrode | 12a: negative uncoated |
| | region |
| 13: separator | 13a: first separator |
| 13b: second separator | 13c: third separator |
| 14: sheet for a rechargeable lithium battery | |
| 14a: first sheet for a rechargeable lithium | |
| battery | |
| 14b: second sheet for a rechargeable lithium | |
| battery | |
| 21: positive electrode terminal | |
| 22: negative electrode terminal | |
| 25: exterior material | 25a: upper exterior |
| | material |
| 25b: lower exterior material | |
| 30: sealing portion | |
| 40: insulation member | |

1. A sheet for a rechargeable lithium battery, the sheet comprising:
a tape including an adhesive surface on a first surface and a non-adhesive surface or an adhesive surface on a second surface; and
a coating layer located on the second surface of the tape and including a metal organic framework.

2. The sheet for a rechargeable lithium battery as claimed in claim 1, wherein the metal organic framework comprises at least one of ZIF-8, MOF-177, Al-MIL-53, HKUST-1, and Fe-BTC.

3. The sheet for a rechargeable lithium battery as claimed in claim 1, wherein a thickness ratio of the coating layer to the tape is 1/5000 to 60.

4. The sheet for a rechargeable lithium battery as claimed in claim 3, wherein a thickness of the coating layer is 10 nm to 5 mm.

5. The sheet for a rechargeable lithium battery as claimed in claim 1, wherein an area of the coating layer is greater than or equal to 0.1 mm² mAh⁻¹, as an area per unit capacity of the rechargeable lithium battery.

6. The sheet for a rechargeable lithium battery as claimed in claim 1, wherein the coating layer is patterned in the shape of a plurality of circles, stripes, rings, or a combination thereof.

7. The sheet for a rechargeable lithium battery as claimed in claim 1, wherein the tape is composed of,
a substrate layer and a first adhesive layer on the first surface of the substrate layer, or
a substrate layer; a first adhesive layer on a first surface of the substrate layer; and a second adhesive layer on a second surface of the substrate layer.

8. The sheet for a rechargeable lithium battery as claimed in claim 7, wherein the substrate layer includes polypropylene.

9. The sheet for a rechargeable lithium battery as claimed in claim 7, wherein the first adhesive layer and the second adhesive layer of the tape each independently include an acrylic polymer.

10. A rechargeable lithium battery, comprising the sheet for a rechargeable lithium battery of claim 1.

11. The rechargeable lithium battery as claimed in claim 10, wherein the rechargeable lithium battery includes an assembly in which a negative electrode; a first separator; and a positive electrode are sequentially stacked, and
the sheet for the rechargeable lithium battery is inserted on an outer surface of the negative electrode side of the assembly; an outer surface of the positive electrode side of the assembly; between the positive electrode and the first separator; or between the negative electrode and the first separator.

12. The rechargeable lithium battery as claimed in claim 11, wherein the rechargeable lithium battery includes a first sheet for a rechargeable lithium battery and second sheet for a rechargeable lithium battery, each located on an outer surface of a negative electrode side of the assembly; and an outer surface of a positive electrode side of the assembly.

13. The rechargeable lithium battery as claimed in claim 12, wherein the rechargeable lithium battery further includes a second separator between the outer surface of the negative electrode side of the assembly and the first sheet for a rechargeable lithium battery.

14. The rechargeable lithium battery as claimed in claim 12, wherein the rechargeable lithium battery further includes a third separator between the outer surface of the positive electrode side of the assembly and the second sheet for a rechargeable lithium battery.

15. The rechargeable lithium battery as claimed in claim 11, wherein the positive electrode includes a composite oxide of lithium and at least one metal selected from nickel, cobalt, manganese, and aluminum as a positive electrode active material.
